(19) United States
(12) Patent Application Publication
(10) Pub. No.: US 2003/0147237 A1
(43) Pub. Date: Aug. 7, 2003

(54) Flashlight

(76) Inventor: Christopher Lee Halasz, Parker, CO (US)

Correspondence Address: John R. Posthumus, Esq., LeBoeuf, Lamb, Greene & MacRae, L.L.P., Suite 2000, 633 Seventeenth Street, Denver, CO, 80202, US

(21) Appl. No.: 10/355,322

(22) Filed: Jan. 31, 2003

Related U.S. Application Data
(60) Provisional application No. 60/353,427, filed on Feb. 1, 2002.

(51) Int. Cl. F21L 4/00

(52) U.S. Cl. 362/187; 362/202; 362/231

(57) ABSTRACT

A flashlight includes a handle, a chamber or body for holding a power source, lens, a lens material, and a plurality of LED lamps. The construction and arrangement of the present invention provides for variability of focus of the light propagating from the lamps.

### RELATED APPLICATION

This application claims priority from U.S. Provisional Application No. 60/353,427, filed on Feb. 1, 2002, which is incorporated herein by reference.

### FIELD OF INVENTION

The present invention relates to the field of flashlights, and more specifically to portable, battery-operated flashlights.

### BACKGROUND OF INVENTION

Illumination devices come in a variety of sizes, shapes and designs. Some are configured to allow the device to be placed on flat horizontal or vertical surfaces. Others are configured to allow the device to be portable.

Portable flashlights allow a user to project light in a particular direction. Unfortunately, in existing flashlights, it is difficult to illuminate an area with more than one light pattern. In addition, conventional flashlights consume a considerable amount of power.

### SUMMARY OF INVENTION

The present invention satisfies, to a great extent, the foregoing and other needs not currently satisfied by existing flashlights. Accordingly, it is a feature and advantage of the present invention to provide an improved flashlight, which provides adjustment of the light illumination from the flashlight between collimated light rays and dispersed light rays being projected on a target area.

Another feature and advantage of the present invention efficiently disperses heat from the light source.

Another feature and advantage of the present invention provides a flashlight that consumes less power.

Another feature and advantage of the present invention provides a flashlight that provides a longer illumination life.

Another feature and advantage of the present invention provides a flashlight that is inexpensive.

Another feature and advantage of the present invention provides a flashlight that is light in weight.

Additional features and advantages of the invention will become hereinafter apparent upon a reading of the following description of the preferred embodiments.

### BRIEF DESCRIPTION OF PREFERRED EMBODIMENTS

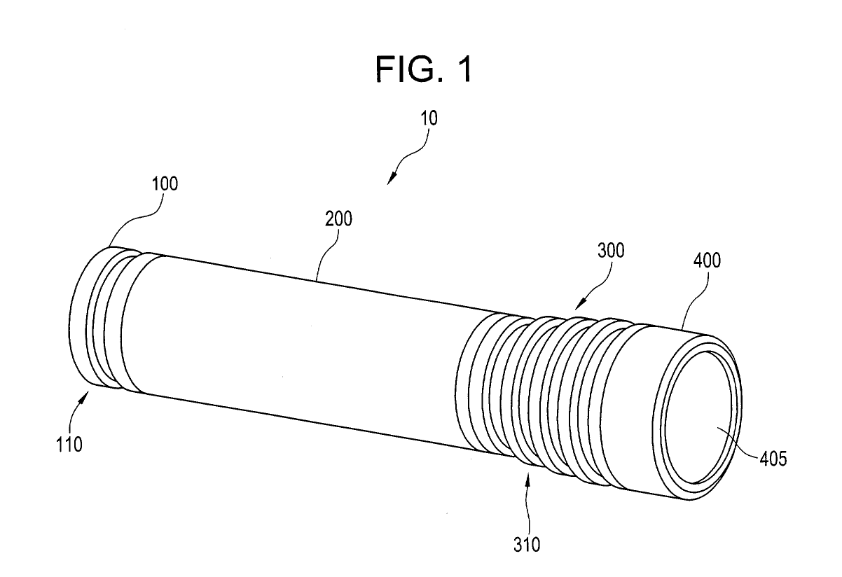

FIG. 1 is a perspective view of the flashlight in accordance with the present invention.

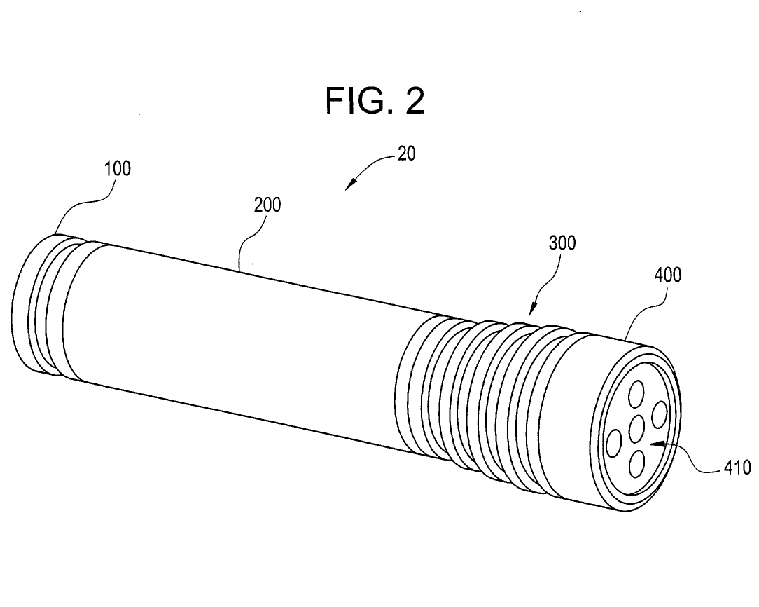

FIG. 2 is a perspective view of an alternative flashlight.

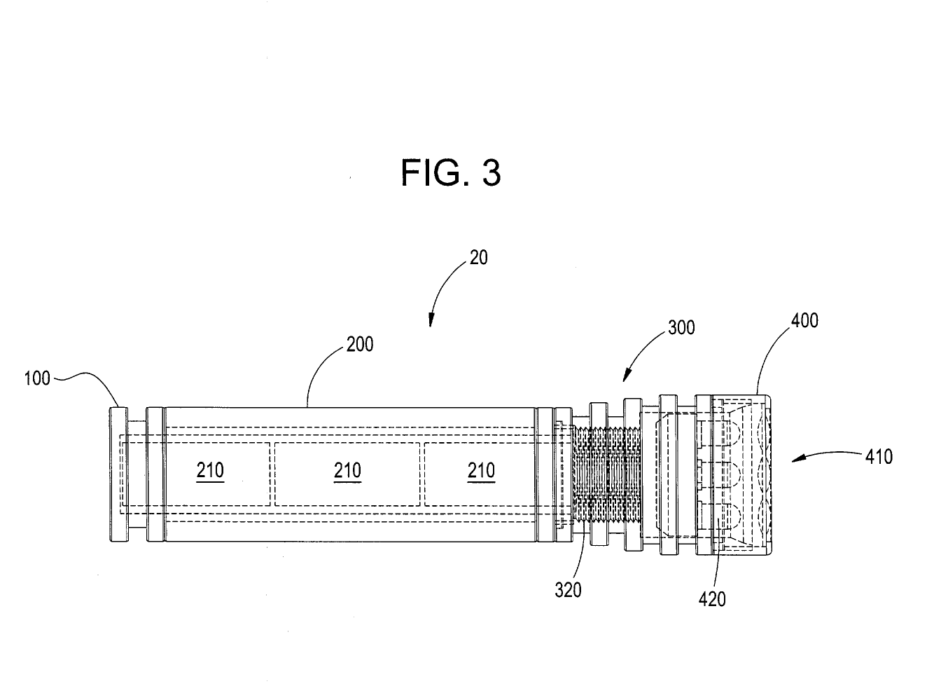

FIG. 3 is a side view of the flashlight of FIG. 2.

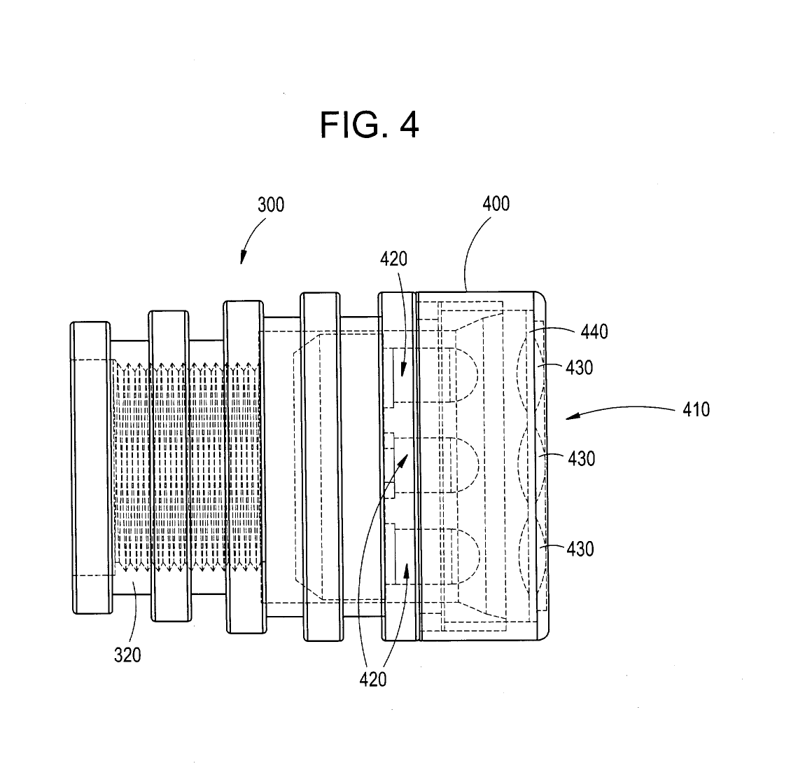

FIG. 4 is a side view of the head assembly.

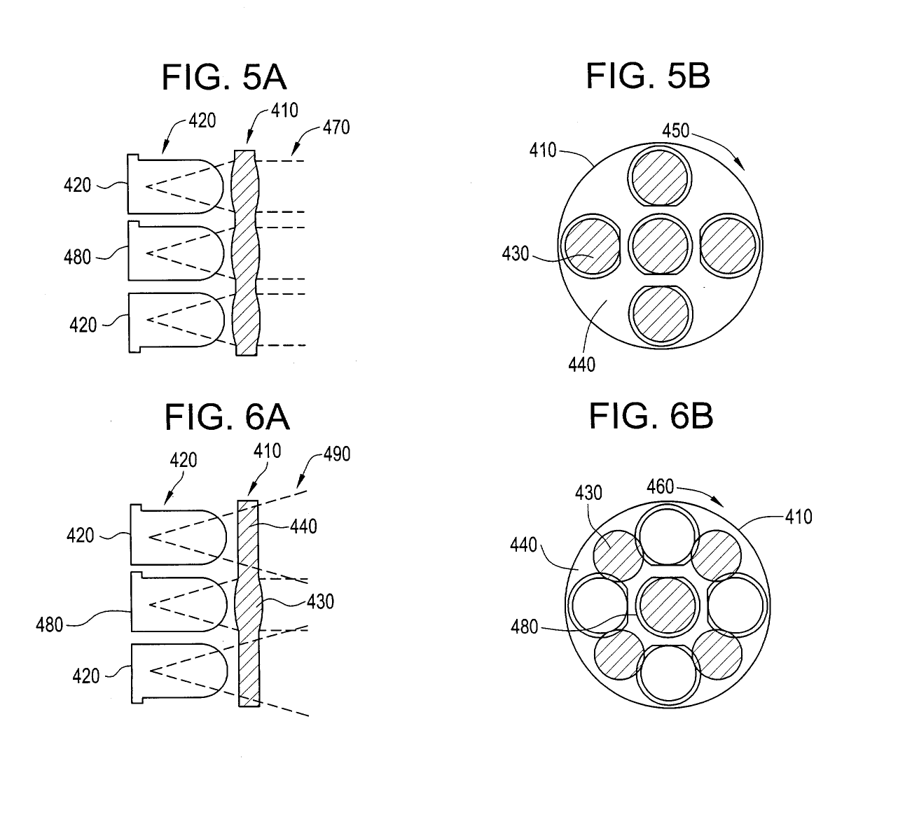

FIG. 5A is a perspective view showing collimated rays.

FIG. 5B is a front view of the bezel/lamp alignment producing the rays of FIG. 5A.

FIG. 6A is a perspective view showing a combination of collimated and dispersed rays.

FIG. 6B is a front view of the bezel/lamp misalignment producing the rays of FIG. 6A.

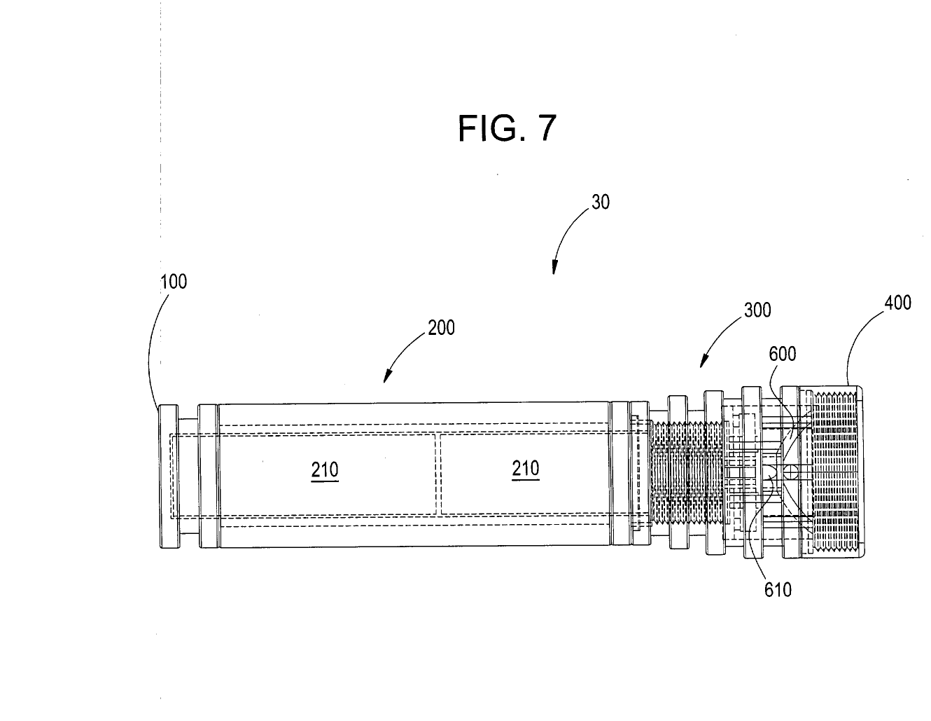

FIG. 7 is another embodiment of the flashlight.

### DETAILED DESCRIPTION OF PREFERRED EMBODIMENTS

Referring to FIG. 1, there is shown a flashlight 10 in accordance with one embodiment of the present invention. As depicted, the flashlight 10 includes an end cap 100, a chamber or body 200 for holding one or more batteries, and a head assembly 300. The end cap 100 is preferably shaped in a bowed configuration to facilitate standing the flashlight 10 on a flat surface.

The head assembly 300 further includes a bezel 400 and a lens 405. Notably, the flashlight 10 includes highly distinctive and ornamental ridges 110 in the vicinity of the end cap 100, as well as ridges 310 in the vicinity of the head assembly 300. In a preferred embodiment, as shown in FIG. 2, the flashlight 20 is interchangeable with a lens assembly 410. More details of the lens assembly may be had with reference to FIG. 4 below.

Referring now to FIG. 3, the flashlight 20 includes an end cap 100, a chamber 200 for holding, in this case, three batteries 210, and a head assembly 300. The head assembly 300 is rotatably connected to the battery chamber 200 by threads 320.

A closer view of the head assembly 300 is shown in FIG. 4. The head assembly 300 is removably attached to the chamber 200. The head assembly 300 further includes the bezel 400, the lens assembly 410 and a Light Emitting Diode (LED) lamp grid 420. The lens assembly 410 includes a multiple lens portion 430 and lens material portions 440. Preferably, the lens assembly 410 snap fits into the bezel 400, and is made of a durable synthetic material that is substantially clear or planar.

Notably, the bezel 400 is configured for rotation relative to the head assembly 300 (i.e. radially) and does not move away from the head assembly 300 (i.e. axially). This rotational configuration allows the bezel 400 to align or misalign with the lamps 420. The bezel may be rotated in the direction 450 (FIG. 5B).

The lens assembly 410 is also rotatable. More specifically, with reference to FIG. 5B, the lens assembly 410 may be rotated, in the direction 450, to cause the lens portion 430 to align with the lamps 420 in the grid. As a consequence, the propagated light from the lamps 420 is collimated, as indicated by the light rays 470 in FIG. 5A.

Conversely, with reference to FIG. 6B, the lens assembly 410 may be rotated, in the direction 460, to cause the lens portion 430 to misalign with the lamps 420 underneath while being aligned with the middle lamp 480. As a consequence, the propagated light from the lamps 420 is dispersed, as indicated by the light rays 490 in FIG. 6A, while the propagated light from the lamp 480 remains collimated.

In another embodiment shown in FIG. 7, the distinctive qualities of the flashlight 30 may also be used in conjunction with a reflector 600 and a filament lamp 610 as the illumination source. Construction and operation of the end cap 100, battery chamber 200, head assembly 300 and bezel 400 is as previously discussed.

Notably, the construction and arrangement of the head assembly 300 and lens assembly 410 allows for focusing and de-focusing of the light emanating from the lamp 600 independent from the radial movement of the head assembly 300 and lens assembly 410. Preferably, the head assembly 300 is rotatable approximately 30 degrees between the “off” and “on” positions.

When assembled, as shown in FIG. 7, the lamp 610 is positioned within an interior of the reflector 600. As such, rotating the bezel 400 relative to the head assembly 300 causes the reflector 600 to move within the bezel 400 axially relative to the head assembly 300. As a result, the reflector 600 moves relative to the lamp 610 to be focused by position the lamp at the reflector's 600 focal point, or defocused by positioning the lamp 610 away from the reflector's focal point. The reflector 600 may be of any desired shape, size or characteristic to achieve the desired result.

The foregoing description of the present invention has been presented for purposes of illustration and description. The description is not intended to limit the invention to the form disclosed herein. Consequently, the invention and modifications commensurate with the above teachings in skill and knowledge of the relevant art are within the scope of the present invention. It is intended that the foregoing description be construed to include all alternative embodiments as permitted by the prior art.

What is claimed is:

1. A flashlight comprising:
(a) a head assembly comprising a bezel, a lens assembly and a lamp grid, said lens assembly is fixed relative to said bezel;
(b) one or more light emitting diodes arranged for directing light toward a target area by rotational movement of a bezel containing one or more lens, said one or more lens variably positioned with respect to each light emitting diode so as to cause variability of focus of each light emitting diode; and
(c) a power source connected to each light emitting diode for providing illumination.
